(19) United States
(12) Patent Application Publication
(10) Pub. No.: US 2017/0199158 A1
(43) Pub. Date: Jul. 13, 2017

(54) System for Detection of a Condition in the Hull of a Marine Asset

(71) Applicant: Michael McDowell, Nanaimo (CA)

(72) Inventor: Michael McDowell, Nanaimo (CA)

(21) Appl. No.: 14/989,917

(22) Filed: Jan. 7, 2016

(51) Int. Cl. G01N 27/90

(52) U.S. Cl. CPC G01N 27/9073; G01N 27/9033

(57) ABSTRACT

The present invention is directed toward system for the detection of a condition present in the hull of a marine asset disposed in a marine environment. The system comprises a plurality of transmitter disposed adjacent the marine asset for delivery of delivery of electrical current to the marine environment toward the marine asset. The system may include a sensor array for measuring fluid current and electro-magnetic fields. In a preferred embodiment, each end of the sensor array is affixed to a survey vessel that travels alongside the marine asset.

### BACKGROUND OF THE INVENTION

Field of the Invention

The present invention is directed toward a system for detection of a condition in the hull of a marine asset, such as damage thereto.

Description of the Related Art

Maintenance of marine assets, particularly large ones, is an expensive and arduous task. The task is particularly made more difficult for marine assets that primarily operate in a corrosive salt water environment. Due to the environment and other factors, conditions commonly develop on the assets, particularly on the hull. Examples of such conditions can range from corrosion and scratches due to wear and tear to more serious structural conditions that, if left unrepaired, could catastrophically compromise the asset. The consequences can be severe and include damage to the marine asset itself and loss of cargo. Further, loss of cargo that is potentially harmful to the environment, such as petrochemicals, can immensely impact the ecosystem and coastal communities.

Accordingly, great efforts are taken to preserve the integrity of the surfaces of the marine assets that interact with the marine environment. These efforts include coating the marine asset with durable or corrosion resistant materials. Nonetheless, while such efforts may slow the development of conditions, vigilantly investigating the state of the marine asset remains vital to ensure its integrity. In fact, inclusion of coatings and other preventative measures often requires inspection of the measures themselves. For example, scratches in a corrosion resistant paint, if left unaddressed, can increase in severity and result of a failure of the corrosion prevention system. However, inspecting marine assets is an arduous and expensive process, particularly in the largest of marine assets, such as transoceanic freighters, that have substantially large hulls. Often, teams of coordinated divers must be employed to inspect those portions of the hull beneath the marine surface.

Therefore, what is needed in the art is a system for detecting conditions present in the hull of marine assets in a manner that is fast, efficient and cost-effective. Such a system may involve disposition of transmitters in an area surrounding the marine asset. The transmitters may deliver electric current into the marine environment. With the use of sensors, which may be dragged under the marine asset by way of survey boats, a two dimensional or three dimensional map of the magnetic field emitted by the vessel can be created. Disturbances or anomalies in the magnetic field can be used to locate and identify conditions in the marine asset.

### SUMMARY OF THE INVENTION

The present invention is directed toward a system for the detection of a condition in the hull of a marine asset disposed in a marine environment. As described herein, such a condition may be, for example, mars; scratches in the coating, paint or surface of the hull; structural damage; superficial damage; and any other occurrence the presence of which affects the state or integrity of the hull. An embodiment of the system comprises transmitters disposed in the marine environment adjacent the marine asset in a configuration at least partially surrounding the marine asset. The transmitters are structured for delivery of electrical current to the marine environment at least partially toward the marine asset. Accordingly, the electrical current interacts with the hull of the marine asset. A sensor array is disposed and transported below the marine asset, some distance from the hull, by way of a pair of survey vessels that travel alongside the marine asset.

The sensor array comprises at least one sensor for detection of properties of the marine environment, which may include fluid current information, electrical current information or information pertaining to the magnetic field. Data gathered from the sensors may then be processed to create a multi-dimensional image of the electromagnetic field lines as they intersect with the hull of the ship. Accordingly, irregularities in the field may be indicative of the location of the presence of a condition in the hull.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a top-down schematic view of an embodiment of the system.

FIG. 2 is a perspective view of the system of FIG. 1.

FIG. 3 is a top-down schematic view of an embodiment of the system.

FIG. 4 is a rear schematic view of the embodiment of FIG. 3.

FIG. 5 is a schematic representation of a model of electromagnetic fields created using data gathered by the system.

Like reference numerals refer to like parts throughout the several views of the drawings.

### DETAILED DESCRIPTION OF THE PREFERRED EMBODIMENT

Both the foregoing general description and the following detailed description are exemplary and explanatory only and are not restrictive of the invention claimed. As used herein, “or” means “and/or” unless expressly stated otherwise. Furthermore, the use of the singular includes the plural unless specifically stated otherwise, and use of the term “including” as well as other forms, such as “includes,” and “included,” shall not be considered limiting.

As represented in the accompanying drawings, the present invention is directed to a system for detection of a condition 4 present in the hull 111 of a marine asset. As used herein, “condition” includes mars; scratches in the coating, paint or surface of the hull; structural damage; superficial damage; and any other occurrence the presence of which affects the state or integrity of the hull, and which is beneficial to detect so as to facilitate repair.

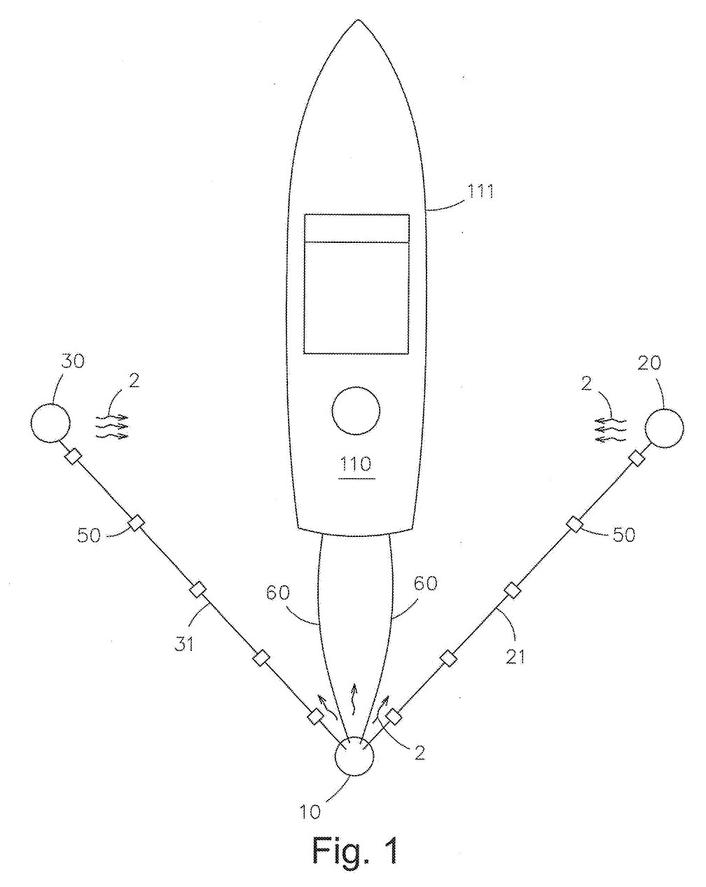

With reference to FIG. 1, an embodiment of the system 1 comprises transmitters 10, 20, 30 disposed adjacent a marine asset 110, which may be, by way of example, a ship, boat, barge, or any other vessel or structure deployed in a marine environment. A first transmitter 10 is disposed approximately equidistant from a second transmitter 20 and third transmitter 30. However, in other conceived embodiments the relationship may not be equidistant. The first transistor array 10 may also comprise a power source for providing electrical current to other elements of the system 1 as described herein. The second transmitter 20 and third transmitter 30 are each disposed on an opposing side of the marine asset 110, such that the marine asset 110 is located between the second and third transmitters 20, 30.

With further reference to FIG. 1, the second and third transmitters 20, 30 are attached to the first transmitter 10 by way of a pair of current carrying members 21, 31 supported by buoyant members 50. Accordingly, the first transmitter 10 may also act as a power source for the second and third transmitters 20, 30. Further, the first transmitter 10 may be disposed in a current carrying relationship with the marine asset 110 by at least one cable 60 that may transport alternating current or direct current.

The transmitters 10, 20, 30 deliver electrical current 2, which may be in the form or forms that includes direct current (DC), alternating current (AC), or both, to the marine environment in which the marine asset 110 is situated. AC current produced by the transmitters 10, 20, 30 may be in the range of 8 to 1000 Hz. The DC current may be rectified current from AC current in the range of 8 to 1000 Hz or in the galvanic/harmonic frequency domain. Additionally, in the event that the system 1 directs both AC and DC current into the marine environment, the DC current may be switched on and off at a set interval to avoid resonance with the AC current.

In addition, in at least one embodiment, the first transmitter 10 produces a different type of current for propagation into the marine environment from that of the second and third transmitters 20, 30. In other words, the first transmitter 10 may produce alternating current and the second and third transmitters 20, 30 may produce direct current. Alternatively, the first transmitter 10 may produce direct current and the second and third transmitters 20, 30 may produce alternating current.

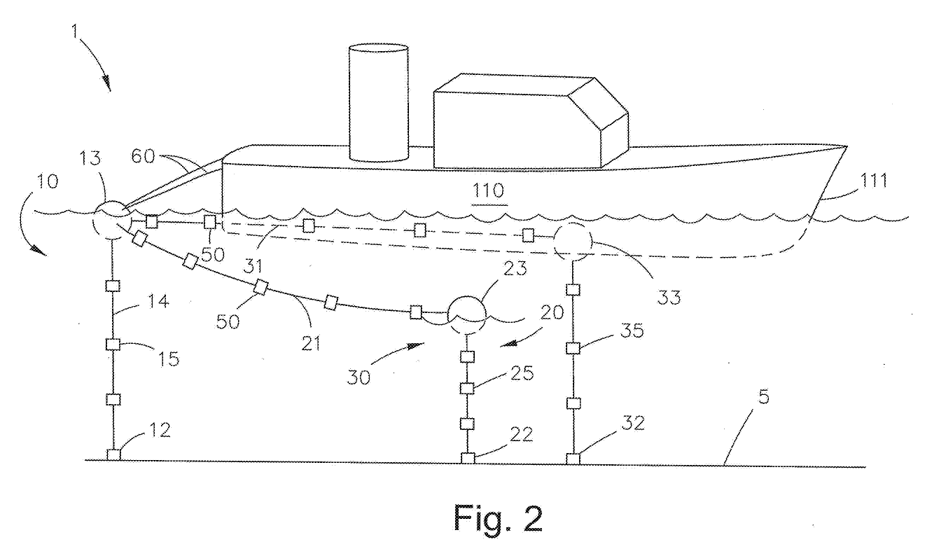

The embodiment of FIG. 2 serves to illustrate further components of the system 1. Each of the transmitters 10, 20, 30 as represented in FIG. 2 comprise a transmission member 13, 23, 33 disposed at or near the surface of the marine environment. Accordingly, the transmission members 13, 23, 33 may comprise a buoyant construction to facilitate such disposition.

The transmission members 13, 23, 33 of FIG. 2 further comprise anchors 12, 22, 32 affixed to the marine environment. Further, the anchors 12, 22, 32 may be affixed to a floor of the marine environment. The anchors 12, 22, 32 serve to restrict movement of the transmission members 13, 23, 33 within the marine environment so as to retain them in their relative positioning as described above. Accordingly, each anchor 12, 22, 32 may be connected to the respective transmission members 13, 23, 33 by way of a connecting member 14, 24, 34, which may be a cord, cable or any other sufficient structure. In at least one embodiment, at least one connecting member 14, 24, 34 is structured to carry electrical current supplied by the respective transmission member 13, 23, 33. At least one conductive member 15, 25, 35 is disposed on the respective connecting member 14, 24, 34. The conductive member or members 15, 25, 35 is structured for delivery of electrical current to the marine environment at least partially toward the marine asset 110. In at least one embodiment, each transmitter 10, 20, 30 comprises a plurality of conductive members 15, 25, 35 disposed in spaced relation along at least a portion of the respective connecting member or members 14, 24, 34. In addition, the conductive members 25, 35 of the second and third transmitters 20, 30 may have sufficient surface area or other structure for delivery of electrical current of 20 milliamps per square meter on the hull 111 of the marine asset 110. Similarly, the conductive member or members 15 of the first transmitter 10 may have sufficient surface area or other structure for delivery of electrical current of 30 milliamps per square meter on the hull 111 of the marine asset 110

In addition, in the system of FIG. 2 the first transmitter is disposed in a current transferring relationship relative the marine asset 110. This may be achieved by way of at least one cable 60. In another embodiment, two cables 60 may be used, with the one being configured to transmit alternating current and the other being configured to transmit direct current.

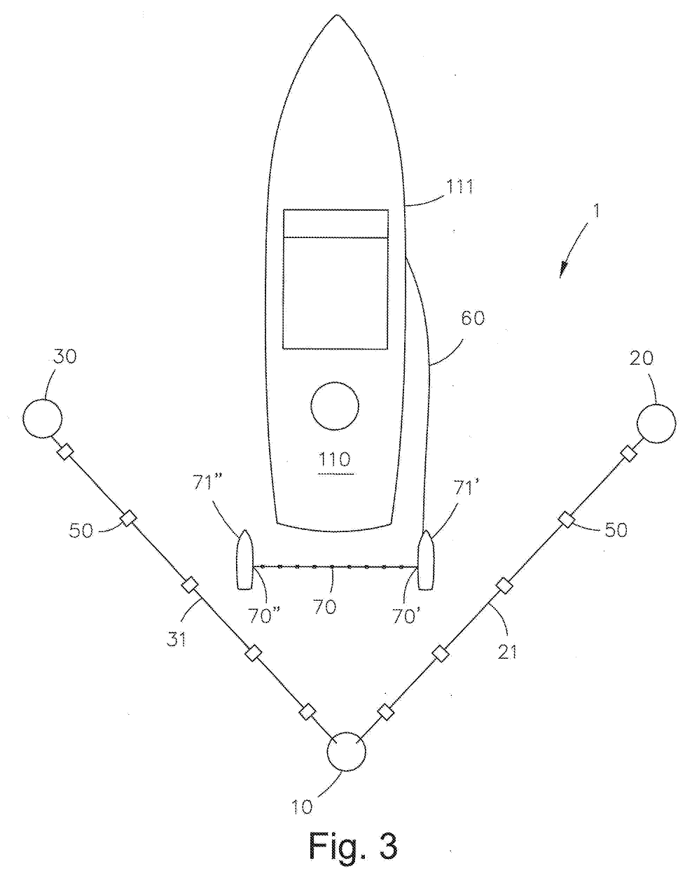

With reference to FIG. 3, the depicted embodiment of the system 1 further comprises a sensor array 70 at least partially disposed in the marine asset. The sensor array 70 comprises first 70′ and second 70″ ends. As shown in FIG. 3, the ends 70′, 70″ are connected to a corresponding survey vessel 71′, 71″. However, it is contemplated that the sensor array 70 may be connected to only a single survey vessel 71′. Further, at least one of the survey vessels 71′, 72′ may be connected to the marine asset 110 by way of a cable 60 for transmission of electrical current. The survey vessels 71′, 72″ travel alongside the marine asset 110, transporting the sensor array 70 below the asset and along a length thereof.

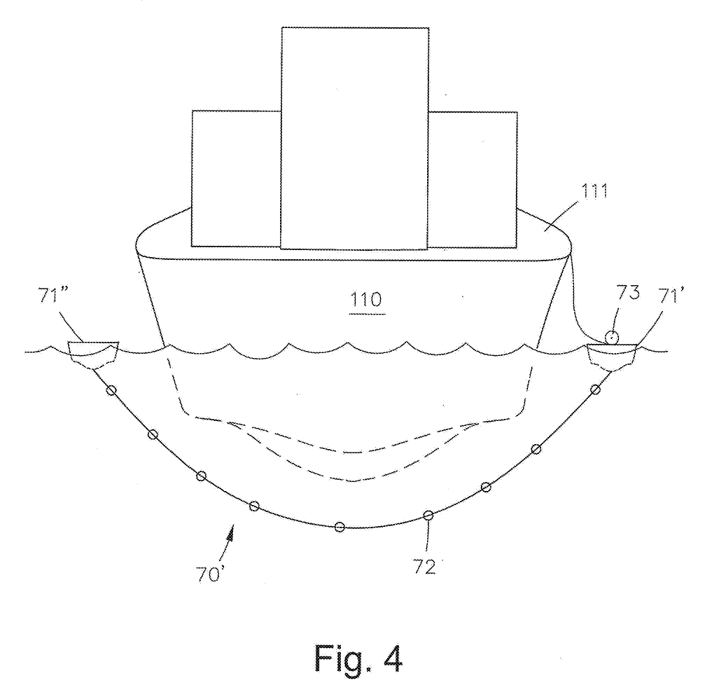

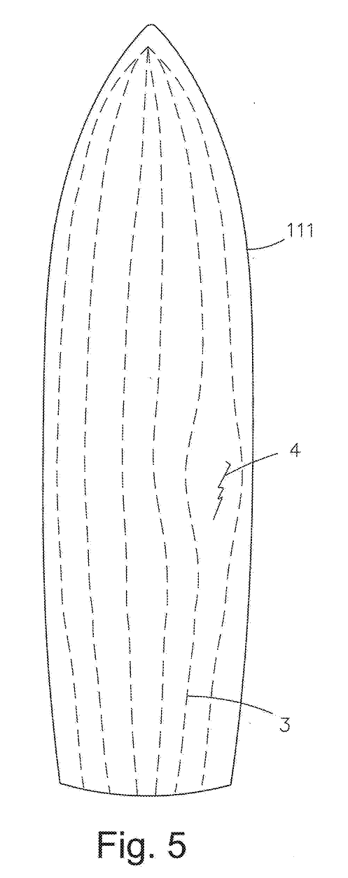

FIG. 4 depicts the sensor array 70 disposed in the marine environment beneath the hull 111 of the marine asset 110 and spaced a distance therefrom. A survey vessel 71′ comprises art. adjustment mechanism 73 to further facilitate disposition of the sensor array 70. The sensor array 70 comprises at least one sensor 72 disposed thereon. In the embodiment of FIG. 5, a plurality of sensors 72 are disposed in spaced relation along the length of the sensor array 70. The sensors 72 may be structured for sensing fluid current, such as the direction and speed, properties of an electromagnetic field, such as amplitude and direction, or properties of electrical current, such as amplitude and voltage.

Through the sensors 72, the sensor array 70 gathers data, such as through steady state data collection or one at a time, about the marine environment and the marine asset 111. Turning now to FIG. 5, this data is used to create a model, which may be in two or three dimensions, of the electromagnetic field 3 running through the hull 111 of the marine asset 110. By locating irregularities in the electromagnetic field 3, a condition 4 (as described above) can be located for future repair.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for the detection of a condition in the hull of a marine asset disposed in a marine environment, said system comprising:
a first transmitter disposed adjacent the marine asset,
a second transmitter disposed adjacent the marine asset,
a third transmitter disposed opposite said second transmitter from the marine asset,
wherein said first, second, and third transmitters are structured for delivery of electrical current to the marine environment at least partially toward the marine asset, and

[symbol]

2. The system of claim 1 wherein said first transmitter is disposed in a current carrying relationship with the marine asset.

3. The system of claim 1 wherein said second and third transmitters are each disposed in a current carrying relationship with said first transmitter.

4. The system of claim 1 wherein said first transmitter is structured for the delivery of alternating current at least partially toward the marine asset.

5. The system of claim 1 wherein said second and third transmitters are structured for delivery of direct current at least partially directed toward the marine asset.

6. The system of claim 1 further comprising at least one survey vessel disposed adjacent the marine asset.

7. The system of claim 6 further comprising a sensor array, having an end thereof affixed to said survey vessel, said sensor array being structured for disposition below the marine asset so as to extend at least partially along a width thereof.

8. The system of claim 7 wherein said sensor array comprises at least one fluid current sensing member.

9. The system of claim 7 wherein said sensor array comprises at least one electro-magnetic field sensor.

10. A system for the detection of a condition in the hull of a marine asset disposed in a marine environment, said system comprising:
a first transmitter disposed adjacent the marine asset,
a second transmitter disposed adjacent the marine asset,
a third transmitter disposed opposite said second transmitter from the marine asset,
wherein said first, second, and third transmitters are structured for delivery of electrical current to the marine environment at least partially toward the marine asset,
a first survey vessel disposed between the second transmitter and the marine asset,
a second survey vessel disposed between the third transmitter and the marine asset,
a sensor array having a first end interconnected with said first survey vessel and a second end interconnected with said second survey vessel, wherein said sensor array is structured for disposition below the marine asset so as to extend at least partially along a width thereof.

11. The system of claim 10 wherein said sensor array comprises at least one fluid current sensor.

12. The system of claim 11 wherein said sensor array comprises a plurality of fluid current sensors.

13. The system of claim 12 wherein said plurality of fluid current sensors is disposed along substantially the length of said sensor array.

14. The system of claim 13 wherein said plurality of fluid current sensors is disposed in spaced relation along the length of said sensor array.

15. The system of claim 10 wherein said sensor array comprises at least one electro-magnetic field sensor.

16. The system of claim 15 wherein said plurality of fluid current sensors is disposed along substantially the length of said sensor array.

17. The system of claim 16 wherein said plurality of fluid current sensors is disposed in spaced relation along the length of said sensor array.

18. A transmitter for the detection of a condition in the hull of a marine asset disposed in a marine environment, said transmitter comprising:
an anchor fixedly engaged to the marine environment,
a current carrying member having a first end and a second end, wherein said first end is interconnected with said anchor,
a transmission member interconnected with said second end of said current carrying member and structured for delivery of electrical current to the marine environment at least partially toward the marine asset, and
at least one conductive element interconnected with said current carrying member between said anchor and said transmission member.

19. The transmitter of claim 18 further comprising a plurality of conductive elements interconnected with said current carrying member between said anchor and said transmission member, wherein said conductive elements are disposed in a spaced relation relative along at least a portion of a length of said current carrying member.

20. The transmitter of claim 18 wherein said conductive element is structured for delivery of electrical current to the marine environment at least partially toward the marine asset.
